(19) United States
(12) Patent Application Publication
(10) Pub. No.: US 2016/0017768 A1
(43) Pub. Date: Jan. 21, 2016

(54) CAMSHAFT ADJUSTER

(71) Applicant: SCHAEFFLER TECHNOLOGIES AG & CO. KG, Herzogenaurach (DE)

(72) Inventors: Holger Brenner, Obermichelbach (DE); Andreas Schulte, Erlangen (DE)

(73) Assignee: SCHAEFFLER TECHNOLOGIES AG & CO. KG, Herzogenaurach (DE)

(21) Appl. No.: 14/768,367

(22) PCT Filed: Nov. 11, 2013
(86) PCT No.: PCT/DE2013/200295

§ 371 Date: Aug. 17, 2015

(30) Foreign Application Priority Data
Feb. 27, 2013 (DE) 10 2013 203 244.7

(51) Int. Cl. F01L 1/344; F16H 53/04

(52) U.S. Cl. CPC F01L 1/344; F16H 53/04

(57) ABSTRACT

A drive element (1) of a camshaft adjuster, the drive element (1) being pot-shaped and having a center receiving portion (3) for an output element that can be connected to a camshaft for conjoint rotation therewith, the drive element (1) including a locking gate (4) and the locking gate (4) protruding beyond the base (6) of the pot-shaped drive element (1) in the axial direction (5) is provided.

### BACKGROUND

Camshaft adjusters are used in internal combustion engines to vary the control times of the combustion chamber valves to be able to vary the phase relation between a crankshaft and a camshaft in a defined angle range between a maximum advance position and a maximum retard position. Adjusting the control times to the instantaneous load and rotational speed reduces consumption and emissions. For this purpose, camshaft adjusters are integrated into a drive train via which a torque is transferred from the crankshaft to the camshaft. This drive train may be designed, for example, as a belt, chain or gear drive.

In a hydraulic camshaft adjuster, the output element and the driving element form one or multiple pair(s) of counteracting pressure chambers to which a hydraulic medium is applied. The driving element and the output element are coaxially situated. A relative movement between the driving element and the output element is created by filling and emptying individual pressure chambers. The rotatively acting spring between the driving element and the output element pushes the driving element toward the output element in an advantageous direction. This advantageous direction may be in the same direction or the opposite direction of the direction of rotation.

One design of the hydraulic camshaft adjuster is the vane-type adjuster. Vane-type adjusters include a stator, a rotor and a drive wheel which has an external toothing. The rotor as the output element is usually designed to be rotatably fixedly connectable to the camshaft. The driving element includes the stator and the drive wheel. The stator and the drive wheel are rotatably fixedly connected to each other or, alternatively, they are designed to form a single piece with each other. The rotor is situated coaxially with respect to the stator and inside the stator. Together with their radially extending vanes, the rotor and stator form oppositely acting oil chambers to which oil pressure may be applied and which enable a relative rotation between the stator and the rotor. The vanes are either designed to form a single piece with the rotor or the stator or are situated as “plugged-in vanes” in grooves of the rotor or stator provided for this purpose. The vane-type adjusters furthermore have various sealing covers. The stator and the sealing covers are secured to each other with the aid of multiple screw connections.

Another design of the hydraulic camshaft adjuster is the axial piston adjuster. In this case, a shifting element, which creates a relative rotation between a driving element and an output element via inclined toothings, is axially shifted with the aid of oil pressure.

A further design of a camshaft adjuster is the electromechanical camshaft adjuster, which has a three-shaft gear set (for example, a planetary gear set). One of the shafts forms the driving element and a second shaft forms the output element. Rotation energy may be supplied to the system or removed from the system via the third shaft with the aid of an actuating device, for example an electric motor or a brake. A spring may be additionally situated, which supports or feeds back the relative rotation between the driving element and the output element.

DE 102 17 062 A1 shows a valve timing control system of an engine with internal combustion which includes a driving force transfer device, a camshaft, [and] a housing. The housing rotates integrally with the driving force transfer device or the camshaft. Furthermore, a vane rotor is disclosed, which is situated inside the housing and which rotates integrally with the respective other driving force transfer device or the camshaft. In addition, DE 102 17 062 shows a locking device and an unlocking device. A section of a large diameter of the locking pin and an internal circumference of a pin hole define a first gap while a section of a small diameter of the locking pin and the inner circumference of the pin hole define a second gap so that the first gap is larger than the second gap.

### SUMMARY OF THE INVENTION

It is an object of the present invention to provide a driving element of a camshaft adjuster and a camshaft adjuster including a driving element which is installed in a particularly space-saving way.

The present invention provides a driving element of a camshaft adjuster, the driving element being formed in the shape of a pot and including a central accommodation for an output element rotatably fixedly connected to a camshaft, the driving element including a locking link, by the locking link protruding in the axial direction beyond the base of the pot-shaped driving element.

In this way it is achieved that, on the one hand, axial installation space, in particular in the area of the hub of the camshaft adjuster or of the driving element, is saved and, on the other hand, the weight of the driving element or of the camshaft adjuster is reduced.

Also, a camshaft adjuster including the driving element mentioned above is provided. The invention is preferably usable in particular in the case of hydraulic camshaft adjusters in vane-type design in which the driving element and the coaxially situated output element each include radially extending vanes, which form hydraulic chambers among one another in order to achieve a rotation between the driving element and the output element.

The driving element has a toothing which may be brought into engagement with a timing assembly. The toothing may be formed by a component separate from the driving element including its vanes, the toothing then being rotationally fixedly connected to the driving element as an axially adjacent component, for example, as a drive wheel or cover. As an alternative, the toothing may be formed integratively with the driving element.

Advantageously, the driving element has a pot-shaped form. The pot-shaped driving element may be designed as a sintered part, whereby the locking link axially protruding from the base and designed integratively with the driving element may be manufactured advantageously easily.

In a driving element designed as a sintered part, the integrative toothing may also be manufactured in a few operational steps.

In one embodiment of the present invention, the locking link is designed pot-shaped and as one piece with the driving element. Advantageously, in a design as a sintered part, the locking link as well as the entire driving element may also be manufactured in very few steps. The pot-shaped locking link protrudes in the axial direction beyond the delimiting surface of the cover, which is also designed as one piece with the driving element.

In one advantageous embodiment, the locking link has been subjected to a heat treatment which is different from that of the rest of the driving element.

In one particularly preferred embodiment, the locking link includes an insert which may be brought into contact with a locking piston. A locking piston may be accommodated by the output element and is movable in the axial direction. For locking a relative movement between the driving element and the output element, the locking piston engages with the locking link. Advantageously, a locking play may be established or minimized with an insert which is captively situated in the locking link. The insert may be made of a material which is different from that of the locking link. The material of the insert is preferably harder than the material of the locking link, and has a larger contact area opposite the locking link than opposite the locking piston. In this way, several different materials may be used which save weight and are less expensive, for example.

In one embodiment of the present invention, the locking link includes a ring which may be brought into contact with a locking piston. The ring is installed in the locking link. Advantageously, a ring may be centered and fixed well in a pot-shaped locking link. Advantageously, a locking play may be established or minimized by the ring, which is captively situated in the locking link. The ring may be made of a material which is different from that of the locking link. The material of the ring is preferably harder than the material of the locking link and has a larger contact area opposite the locking link than opposite the locking piston. In this way, several different materials may be used which save weight and are less expensive, for example.

The ring is fixedly joined to the locking link with a press fit.

In one preferred embodiment, the locking link includes a pot-shaped insert which is accommodated in an opening of the driving element and which may be brought into contact with a locking piston. The locking link is here formed as a single part and is joined with the driving element. The insert is inserted into the opening of the driving element. The locking piston may lock into the pot shape of the locking link designed as a single part. The base of the pot-shaped insert protrudes in the axial direction beyond the delimiting surface of the cover designed integratively with the driving element.

The pot-shaped insert is joined with the opening of the driving element using a press fit. The opening is designed as a blind hole or a through-hole.

In another embodiment of the present invention, the ring or the pot-shaped insert has a protruding collar with which the ring or the pot-shaped insert is fixed in the axial direction. If the ring or the pot-shaped insert is inserted into the locking link or the opening of the driving element, the collar ensures that a defined axial position is achieved and maintained.

In one embodiment of the present invention, the collar is situated on the inside of the pot-shaped driving element. Advantageously, the collar may rest on the driving element when a hydraulic medium pressure acts on the locking link.

In one advantageous embodiment, the ring or the pot-shaped insert has an anchoring structure on the outer circumference. The anchoring structure is in the form of a circumferential ribbing or in the form of a knurl. The anchoring structure increases the reliability of the connection between the ring and the locking link or between the pot-shaped insert and the opening.

The inner diameter of the ring or of the pot-shaped insert may be situated eccentrically with respect to the outer diameter. By rotating the ring or the pot-shaped insert, the inner diameter and thus the accommodation for the locking piston may be set to be flush with the ring, which makes it possible to subsequently adjust the locking play. The ring or the pot-shaped insert here has a recess for engagement with an adjustment tool, for example, a groove or a slot. Advantageously, this recess is formed by the outer base surface of the pot-shaped insert in order to be able to measure or, if necessary, to adjust a locking play also after the installation of the entire camshaft adjuster has been carried out.

A driving element may have multiple locking links having the designs mentioned above.

Due to the design of the driving element according to the present invention and its locking link, an installation-space-saving arrangement as well as a reduction in weight is achieved.

### BRIEF DESCRIPTION OF THE DRAWINGS

Exemplary embodiments of the present invention are shown in the figures.

FIG. 1 shows a sectional view of a driving element according to the present invention of a camshaft adjuster;

FIG. 2 shows a detailed view of the locking link of a driving element according to the present invention of a camshaft adjuster;

FIG. 3 shows a sectional view of a specific embodiment of a pot-shaped insert including a collar;

FIG. 4 shows a sectional view of a specific embodiment of a pot-shaped insert including an anchoring structure;

FIG. 5 shows a top view of a specific embodiment of a pot-shaped insert including an eccentric design of the inner diameter with respect to the outer diameter, and

FIG. 6 shows a sectional view of a specific embodiment of a pot-shaped insert including an eccentric design of the inner diameter with respect to the outer circumference.

### DETAILED DESCRIPTION

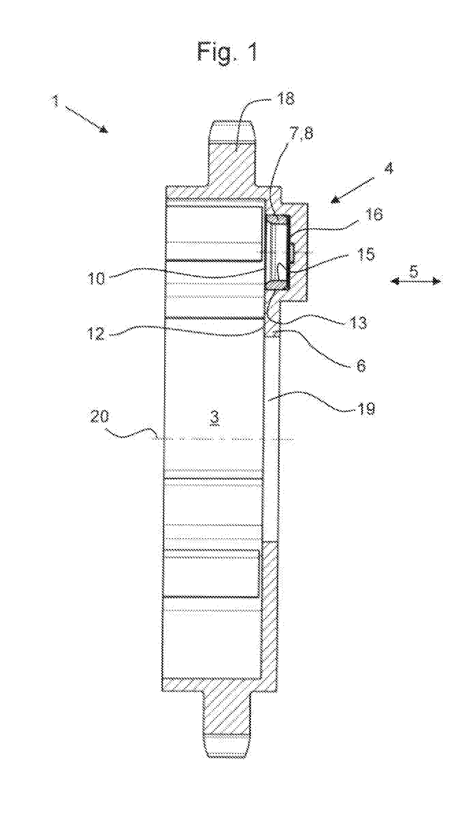

FIG. 1 shows a sectional view of a driving element 1 according to the present invention of a camshaft adjuster.

Driving element 1 has a pot-shaped design. A toothing 18 integrally formed with driving element 1 is situated at the outer circumference of driving element 1. Pot-shaped driving element 1, which is preferably formed as a sintered part, also has a base 6 which has a central opening 19 situated coaxially to rotation axis 20 of the camshaft adjuster and of driving element 1. Central opening 19 may be penetrated by a camshaft and rotatably fixedly connected to an output element situated inside central accommodation 3. Driving element 1 and the output element, which is not shown, form a camshaft adjuster with additional components in the form of a vane-type adjuster.

From base 6 of driving element 1, a locking link 4 is formed. Locking link 4 protrudes beyond the front surface of base 6 facing away from inner side 12 in axial direction 5. Locking link 4 has an opening 10 into which a ring 8 formed as an insert 7 is inserted Inner circumference 15 and outer circumference 13 formed by ring 8 are situated coaxially to one another. Ring 8 is captively joined with opening 10, for example, using a press-fit. Opening 10 is not formed continuously, whereby ring 8 rests on base 16 of locking link 4 formed by driving element 1. Base 16 and base 6 have nearly the same wall thickness in axial direction 5, a driving element 1 formed as a sintered part having opening 10 [and] toothing 18 easily being manufactured.

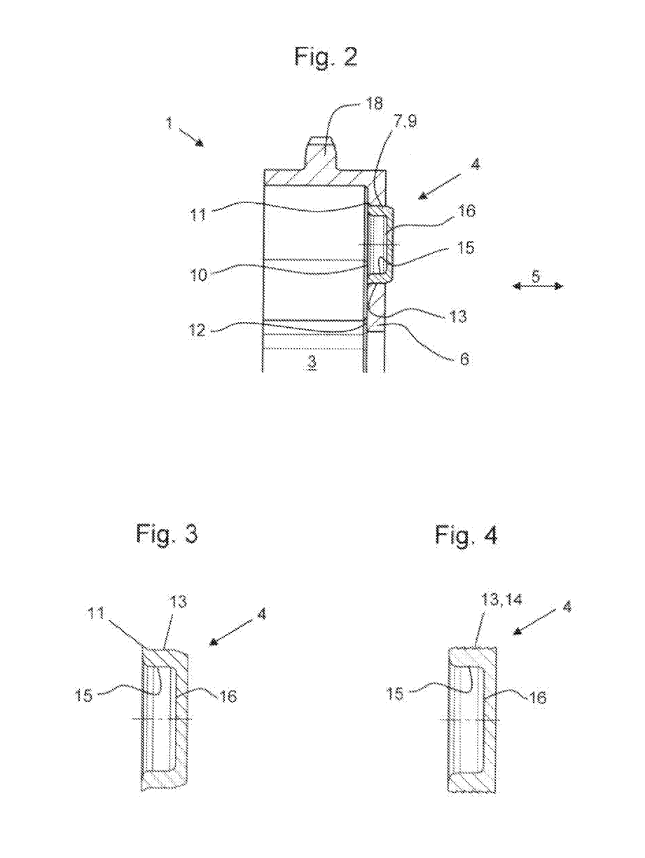

FIG. 2 shows a detailed view of locking link 4 of a driving element 1 according to the present invention of a camshaft adjuster.

Unlike in FIG. 1, locking link 4 is formed by a pot-shaped insert 9 which has base 16. Opening 10 of driving element 1 is formed continuously in FIG. 2 and accommodates the pot-shaped insert 9 at its outer circumference 13. In order to establish the axial position between pot-shaped insert 9 and driving element 1, pot-shaped insert 9 has a collar 11. This collar is flush with its inner side 12. The flush connection may be formed by a manufacturing step in the case of a joined pot-shaped insert. Base 6 thus has a continuously planar inner side 12 as well as an outer side which is situated in axial direction 5 opposite inner side 12. Base 16 of the pot-shaped insert 9 protrudes beyond this outer side.

FIG. 3 shows a sectional view of a specific embodiment of a pot-shaped insert 9 including a collar 11.

Pot-shaped insert 9 shown in FIG. 3 corresponds to the embodiment according to FIG. 2. The inner diameter of inner circumference 15 and the outer diameter of outer circumference 13 are situated coaxially to one another. Collar 11 is now clearly visible, which advantageously protrudes radially and is formed circumferentially in order to establish the axial position between pot-shaped insert 9 and driving element 1. Advantageously, the pot-shaped insert may be formed by a forming manufacturing process, for example, deep drawing or impact extrusion. Possible finishing at inner circumference 15 or at outer circumference 13 may take place.

FIG. 4 shows a sectional view of a specific embodiment of a pot-shaped insert 9 including an anchoring structure 14.

Pot-shaped insert 9 has an anchoring structure 14 at its outer circumference 13 which may engage with opening 10 of driving element 1. This design of the anchoring structure enables a joining from the direction of the side of driving element 1 facing away from inner side 12. Advantageously, the defined position of pot-shaped insert 9 with respect to driving element 1 is maintained when a locking piston engages into inner circumference 15 and, if necessary, the locking piston itself or a hydraulic medium pressure for unlocking presses against base 16, since anchoring structure 14 here supports the therein resulting forces.

Anchoring structure 14 is formed as multiple, wedge-shaped, circumferential webs. As an alternative, the anchoring structure may be formed as a knurl or as multiple, wedge-shaped, non-circumferential webs.

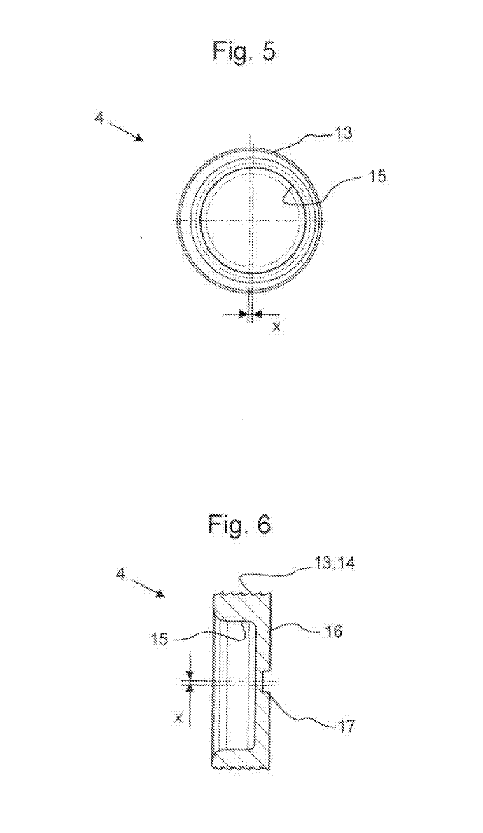

FIG. 5 shows a top view of a specific embodiment of a pot-shaped insert 9 including an eccentric embodiment of the inner diameter with respect to the outer diameter.

The inner diameter of inner circumference 15 is not situated coaxially to the outer diameter of outer circumference 13. Their middle axes have an offset x.

FIG. 6 shows a sectional view of a specific embodiment of a pot-shaped insert 9 including an eccentric embodiment of the inner diameter with respect to the outer diameter.

The section shown in FIG. 6 is deviated from the embodiment of the pot-shaped insert from FIG. 5. Furthermore, an anchoring structure 14 is visible, which is formed as multiple, wedge-shaped, circumferential webs. In addition, offset x is illustrated in greater detail. Furthermore, base 16 has a groove 17 at its outer side. With the aid of this groove 17, pot-shaped insert 9 may be rotated around its own axis in opening 10 of driving element 1; inner circumference 15 may thereby, due to offset x, be adjusted to be flush relative to a locking piston, or be adjusted to minimize a locking play. Regardless of the rotational adjustment, anchoring structure 14 secures the axial position between pot-shaped insert 9 and driving element 1. A settable and easily manufacturable locking link 4 is thus formed.

### LIST OF REFERENCE NUMERALS

1) driving element
3) central accommodation
4) locking link
5) axial direction
6) base
7) insert
8) ring
9) pot-shaped insert
10) opening
11) collar
12) inner side
13) outer circumference
14) anchoring structure
15) inner circumference
16) base
17) groove
18) toothing
19) central opening
20) rotation axis

1-10. (canceled)

11. A driving element of a camshaft adjuster, the driving element being pot-shaped and comprising:
a central accommodation for an output element rotatably fixedly connectable to a camshaft;
a base; and
a locking link protruding in an axial direction beyond the base.

12. The driving element as recited in claim 11 wherein the locking link is pot-shaped and formed as a single part by the driving element.

13. The driving element as recited in claim 12 wherein the locking link has been subjected to a heat treatment different from that of a remainder of the driving element.

14. The driving element as recited in claim 11 wherein the locking link includes an insert capable of being brought into contact with a locking piston.

15. The driving element as recited in claim 11 wherein the locking link includes a ring capable of being brought into contact with a locking piston.

16. The driving element as recited in claim 15 wherein the ring has a protruding collar fixing the ring in the axial direction.

17. The driving element as recited in claim 16 wherein the collar is situated on an inner side of the pot-shaped driving element.

18. The driving element as recited in claim 15 wherein the ring has an anchoring structure at an outer circumference.

19. The driving element as recited in claim 11 wherein the locking link includes a pot-shaped insert accommodatable in an opening of the driving element and capable of being brought into contact with a locking piston.

20. The driving element as recited in claim 19 wherein the pot-shaped insert has a protruding collar fixing the pot-shaped insert in the axial direction.

21. The driving element as recited in claim 20 wherein the collar is situated on an inner side of the pot-shaped driving element.

22. The driving element as recited in claim 19 wherein the pot-shaped insert has an anchoring structure at an outer circumference.

23. A camshaft adjuster comprising the driving element as recited in claim 11.
